(19) United States
(12) Patent Application Publication
(10) Pub. No.: US 2026/0060213 A1
(43) Pub. Date: Mar. 5, 2026

(54) INFERENTIAL SMART PET COLLAR

(71) Applicant: Ten To 100 Products, LLC, Morrison, CO (US)

(72) Inventors: Adam WENGERT, Morrison, CO (US); Joel DANOWITZ, Champaign, IL (US)

(21) Appl. No.: 19/315,308

(22) Filed: Aug. 29, 2025

Related U.S. Application Data
(60) Provisional application No. 63/688,609, filed on Aug. 29, 2024.

(51) Int. Cl. A01K 15/02; A01K 27/00; G06N 20/00

(52) U.S. Cl. CPC A01K 15/021; A01K 27/001; A01K 27/009; G06N 20/00

(57) ABSTRACT

Smart pet collars adopt electronic features, such as wireless fencing, behavior feedback, automatic pet door activation, location tracking, and so on. However, prior smart pet collars do not incorporate multiples of these features, let alone a sensor fusion of data to provide new and improved insights into pet behavior. A sensor fusion of outputs from an IMU combined with other sensor outputs to infer predictable peculiarities of pet behavior using AI. As pet behaviors are largely predictable and repeatable, the presently disclosed technology utilizes ML to build models of sensor outputs that correspond to specific pet behaviors and refine those models over time as additional data becomes available. A software tool backed by an AI model iteratively tunes a training data set of sensor outputs that correspond to pet behaviors to update and optimize the models of sensor outputs to better assess future pet behaviors.

### CROSS-REFERENCE TO RELATED APPLICATIONS

The present application claims benefit of priority to U.S. Provisional Patent Application No. 63/688,609, entitled “Inferential Smart Dog Collar,” and filed on Aug. 29, 2024, which is specifically incorporated by reference herein for all it discloses or teaches.

### BACKGROUND

A pet collar is a piece of material put around a pet's neck and is used for restraint, identification, fashion, protection, and training, for example. Identification tags and medical information are often placed on pet collars (e.g., via one or more tags) and are often used with a leash for restraining a pet. Smart pet collars adopt electronic features such as wireless fencing, behavior (e.g., bark training), automatic pet door activation, location tracking, and so on, into the pet collar.

### SUMMARY

Implementations described and claimed herein address problems with conventional solutions using a method for training a pet behavior model using an inferential smart pet collar. The method comprises identifying a set of pet behaviors, detecting a sensor fusion of outputs from sensors internal to the inferential smart pet collar as a pet wears the inferential smart pet collar, training a machine-learning (ML) enabled pet behavior engine with sensor fusion snapshots at times the set of pet behaviors occurred, and inferring future pet behaviors using the trained ML enabled pet behavior engine.

Implementations described and claimed herein further address problems with conventional solutions using an inferential smart pet collar comprising an inertial measurement unit (IMU) to provide pet orientation data, a locating unit to provide pet position data, and an ML-enabled pet behavior engine. The ML-enabled pet behavior engine infers future pet behaviors using a set of past pet behaviors, the pet orientation data, and the pet position data.

Other implementations are also described and recited herein.

### BRIEF DESCRIPTION OF THE DRAWINGS

FIG. 1 illustrates a dog wearing an inferential smart pet collar and various internal features of the pet collar.

FIG. 2 illustrates an inferential smart pet collar used wirelessly with a correction pet collar.

FIG. 3 illustrates a logical diagram of identified behaviors, rules set around the behaviors, and actions to be taken in response to the behaviors using an inferential smart pet collar.

FIG. 4 illustrates an example method for using an inferential smart pet collar to train a pet behavior model and subsequently infer pet behaviors.

FIG. 5 illustrates an example system diagram of a computer system suitable for implementing aspects of an inferential smart pet collar.

### DETAILED DESCRIPTION

As noted above, prior smart pet collars may adopt an electronic feature, such as wireless fencing, behavior modification (e.g., bark training), automatic pet door activation, location tracking, and so on, into the pet collar. Prior smart pet collars do not incorporate multiples of these features, let alone a sensor fusion of data collected by the smart pet collar to provide new and improved insights into pet behavior. While the following description focuses on the inferential smart pet collar as used with a pet dog, other trainable pets may similarly use the inferential smart pet collar (e.g., horses, cats, etc.).

The presently disclosed technology leverages sensor fusion of outputs from an inertial measurement unit (IMU or IMMU) combined with other sensor outputs to infer predictable peculiarities of pet behavior using artificial intelligence (AI). As such behaviors are largely predictable and repeatable, the presently disclosed technology further utilizes machine learning (ML) to build models of sensor outputs that correspond to specific pet behaviors and refine those models over time as additional data becomes available. A software tool backed by an artificial intelligence model iteratively tunes a training data set of sensor outputs that correspond to pet behaviors to update and optimize the models of sensor outputs to better assess future pet behaviors.

The presently disclosed technology improves on prior smart pet collars by leveraging various internal sensors and AI to infer pet behaviors. These inferred pet behaviors can then be compared to a library of rules that can automate aspects of pet training to repeat desirable behaviors and avoid undesirable behaviors. This is an improvement over the prior smart pet collars that do not actively infer pet behaviors, let alone apply rules to the inferred pet behaviors. Further details on the benefits and implementations are explored below.

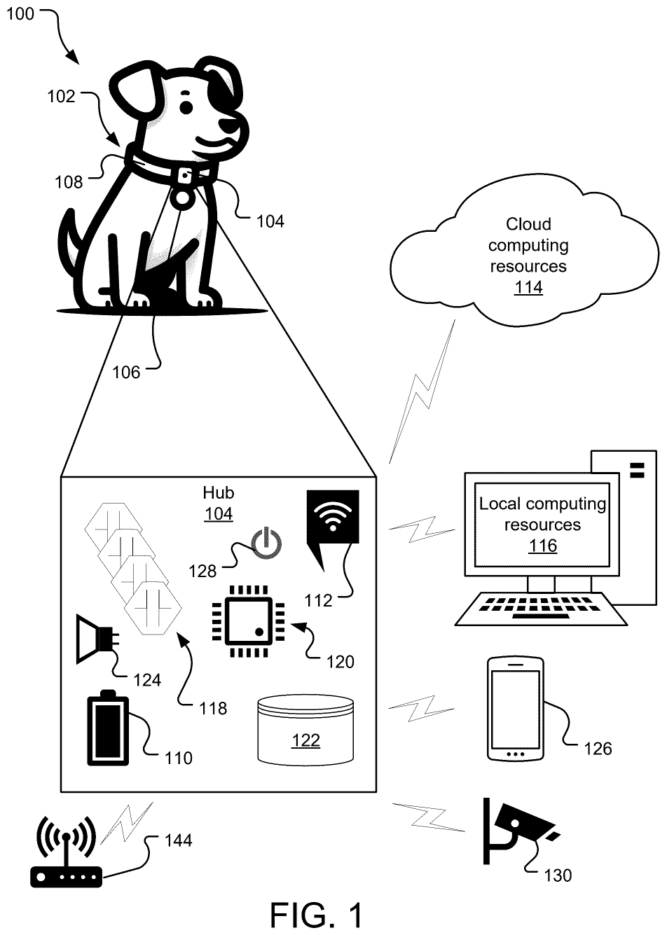

FIG. 1 illustrates a dog 100 wearing an inferential smart pet collar 102 and various internal features of the pet collar 102. The dog 100 (e.g., Canis familiaris or Canis lupus familiaris) may be any domesticated breed wherein a dog owner wishes to exert control over its behavior. While the following disclosure is specific to dogs, the presently disclosed technology may equally apply to other domesticated and trainable animals to be treated as pets (e.g., horses, goats, cats, rabbits, ferrets, some pigs, and rodents).

The pet collar 102 includes a ring of material 108 (e.g., leather or textile) put around the neck of the dog 100 and one or more attached collar hubs (e.g., collar hub 104) that contain various internal features that drive various functionalities, all discussed below, of the dog collar 102. The inferential smart pet collar 102 may also include a tag 106 with identifying or medical information specific to the dog or its owner.

The collar hub 104 is a computing device that includes an array of sensors 118 used to detect the dog's position, orientation, location, environment, etc., and using machine learning, infer the dog's behavior. The sensors 118 may include an inertial measurement unit (IMU or IMMU) that tracks the dog's specific force, angular rate, and orientation, using a combination of one or more accelerometers, gyroscopes, and magnetometers. The sensors 118 may include position sensors (e.g., global positioning system (GPS), real-time kinematic positioning (RTK) that may utilize GPS (CPGPS), locational beacons, etc.) to aid the IMU in accurately tracking the dog's location. The sensors 118 thus generate pet orientation and position data. The sensors 118 may further include one or more environmental sensors (e.g., temperature, humidity, barometric pressure, illumination, etc.) to access the dog's environmental conditions. The sensors 118 may further include audio/video sensors (e.g., microphones, video cameras, etc.) to assess the dog's surroundings or activities. The sensors 118 may further include a pulse or heart rate monitor (HRM) to assess the dog's activity level and/or state of health. The sensors 118 provide data that may be combined using an implementation of sensor fusion to infer the dog's state of being and behavior.

The collar hub 104 is powered via battery 110 and includes a wireless communications link 112 that allows the collar hub 104 to connect to a wide area network (WAN) and access data and processing power on cloud computing resources 114 and/or a local area network (LAN) and access data and processing power on local computing resources 116 (e.g., one or more computing device interconnected on a local network). The battery 110 may be replaceable or rechargeable (e.g., via wired power connection, wireless power connection, or movement charging) and come in various formats, including but not limited to traditional cylindrical cells, pouch cells, and flexible batteries.

In some implementations, various features of the collar hub 104 may be selectively powered by the battery 110 depending upon the use state of the collar hub 104 and the battery 110 state of charge. For example, a training mode may utilize higher power than a sensing mode of the collar hub 104, as some features may only be used on certain use states (e.g., the feedback mechanisms 124 may only be used in the training mode). The collar hub 104 may switch various features off or to a standby power consumption state when not immediately needed, depending on the current use case of the collar hub 104, to conserve power. The training mode or sensing mode (or other use states) may be automatically detected by the collar hub 104 or manually selected by the user.

The wireless communications link 112 may operate over various wireless communication standards (e.g., LoRaWAN™, Wi-Fi®, Bluetooth®, Bluetooth® Low Energy (BLE)). While wireless connections are illustrated (e.g., via lightning bolts), the collar hub 104 may similarly connect to the WAN or LAN via a wired connection. Various components and functionalities of the collar hub 104 may be incorporated into a singular printed circuit board (PCB) or a collection of PCBs. These PCBs may have a rigid or flexible substrate. This minimizes the size of the collar hub 104 and maximizes its overall functionality.

Separate from or in addition to the connection to the LAN, the collar hub 104 may be wirelessly connected to a smartphone 126 that is used to control various features of the collar hub 104 via a smartphone application. As the collar hub 104 may lack user input features, aside from a power button 128, the smartphone 126 via the smartphone application may serve as the primary user input device for the collar hub 104. The collar hub 104 may also be wirelessly connected to an external hub 144 that is also used to control various features of the collar hub 104, either in lieu of the smart phone 126 or in addition to the smart phone 126. In some implementations, the external hub 144 is another pet collar used as a hub for a set of pet collars, such as pet collar 102, each applied to a pet.

In various implementations, the local computing resources 116, the smartphone 126 and/or the external hub 144 may provide the collar hub 104 with additional computing resources offloaded from the collar hub 104, provide a geolocation reference point(s), and support the wireless communication. To that end, the local computing resources 116, the smartphone 126 and/or the external hub 144 may include a physical connection to a LAN or WAN (e.g., via Ethernet) and include a wireless communications link that may operate over a variety of wireless communication standards (e.g., LoRaWAN™, Wi-Fi®, Bluetooth®, BLE). The external hub 144 may operate as a LoRa gateway, an RTK device, or a pass-through. In other implementations, the collar hub 104 includes sufficient computing resources and wireless communication features. It may connect to a LAN or WAN without using the local computing resources 116, the smartphone 126 and/or the external hub 144.

External input devices 130, such as video camera feeds, may further be wirelessly connected to the collar hub 104 and provide additional data that is combined with the data pulled from the sensors 118 using an implementation of sensor fusion to infer the dog's state of being and behavior. The external input devices 130 may also provide external data not specific to the inferential smart pet collar 102 (e.g., time, date, weather conditions, etc.).

The collar hub 104 further includes one or more processor(s) 120 and data storage 122. The processor(s) 120 (e.g., CPU(s), GPU(s), or TPU(s)) use sensor fusion to apply the outputs from the sensors 118 in a manner that infers the dog's state of being and behavior using an artificial intelligence (AI) enabled model. The processor(s) 120 work with cloud computing resources 114 and/or local computing resources 116 to provide the disclosed functionalities of the pet collar 102. The data storage 122 allows local storage of sensor measurements, potential dog behaviors, and rules set around the dog behaviors. The data storage 122 also works in conjunction with cloud computing resources 114 and/or local computing resources 116, and in some cases, it may only be temporary storage, or the data storage 122 may be omitted entirely.

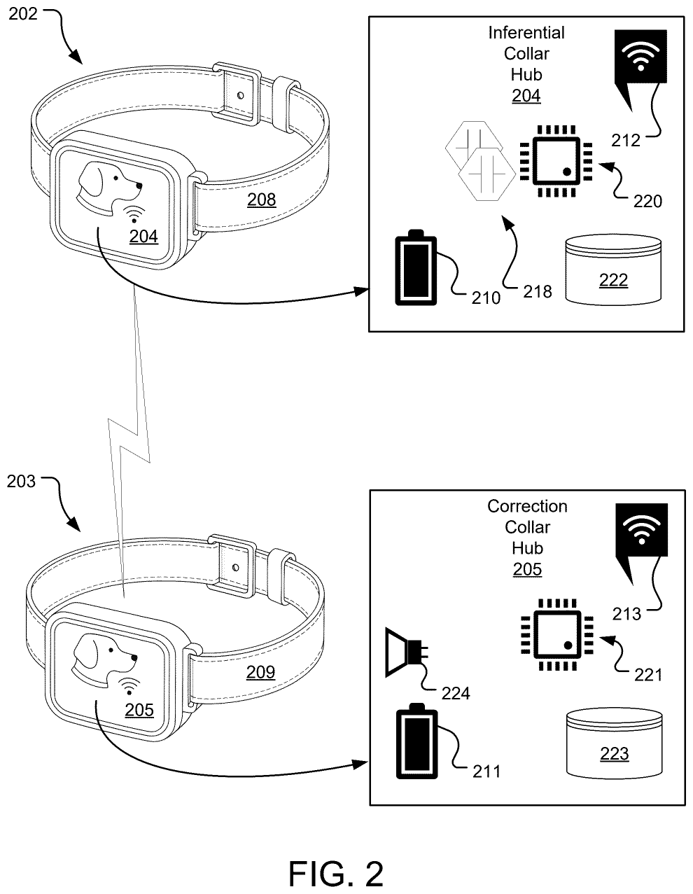

In some implementations, the collar hub 104 further includes one or more feedback mechanisms 124 that positively or negatively reinforce inferred dog behavior. Feedback mechanisms 124 that provide negative feedback for undesirable dog behaviors (e.g., peeing and defecating indoors) may include triggering an unpleasant sound (e.g., a high-pitched noise), vibration, electric shock, or puff of air. Feedback mechanisms 124 that provide positive feedback for desirable dog behaviors (e.g., peeing and defecating outdoors) may include remotely activating an automatic treat feeder or pinging a dog owner to provide a treat or play time to the dog immediately. In other implementations, the pet collar 102 omits some or all of the feedback mechanisms 124 and instead connects to a separate device (e.g., correction collar 203 of FIG. 2) to provide that functionality.

FIG. 2 illustrates an inferential smart pet collar 202 used wirelessly with a correction pet collar 203. The pet collars 202, 203 include rings of material 208, 209 put around the neck of a dog or other pet (not shown, see e.g., dog 100) and collar hubs 204, 205 that contain various internal features that drive various functionalities of the pet collars 202, 203, respectively.

The collar hub 204 is a computing device that includes an array of sensors 218 used to detect the dog's position, orientation, location, environment, etc., and using machine learning, infer the dog's behavior. The sensors 218 may include IMU(s), position sensor(s), environmental sensor(s), audio/video sensor(s), pulse or HRM sensor(s). The sensors 218 provide data that may be combined using an implementation of sensor fusion to infer the dog's state of being and behavior.

The collar hub 205 is a separate computing device that includes one or more feedback mechanisms 224 that positively or negatively reinforce inferred dog behavior. Some feedback mechanisms 224 may provide negative feedback for undesirable dog behaviors, including triggering an unpleasant sound, vibration, electric shock, or puff of air, for example. Other feedback mechanisms 224 may provide positive feedback for desirable dog behaviors and may include remotely activating an automatic treat feeder or pinging a dog owner to provide a treat or play time to the dog immediately.

The collar hubs 204, 205 are powered via batteries 210, 211 and include wireless communications links 212, 213, respectively, that allow the hubs 204, 205 to connect to one another, as well as connect to a WAN and/or LAN. The wireless communications links 212, 213 may each operate over various wireless communication standards. Further, while a wireless connection between the collar hubs 204, 205 is illustrated (e.g., via a lightning bolt), the collar hubs 204, 205 may be similarly connected to each other, the WAN, or the LAN via a wired connection.

One or both of the collar hubs 204, 205 may further include one or more processor(s) 220, 221 and data storage units 222, 223, respectively. One or both of the processor(s) 220, 221 use sensor fusion to apply the outputs from the sensors 218 in a manner that infers the dog's state of being and behavior using an artificial intelligence (AI) enabled model. The processor(s) 220, 221 may further communicate to administer the feedback mechanisms 224 as directed by the dog's state of being and behavior. The data storage units 222 and 223 allow for local storage of sensor measurements, potential dog behaviors, rules set around the dog behaviors, and rules for administering the feedback mechanisms 224, as examples. In some cases, one or both of the data storage units 222, 223 may be only temporary storage or may be omitted entirely. Various components and functionalities of the collar hubs 204, 205 may be incorporated into a singular printed circuit board (PCB) or a collection of PCBs.

In some implementations, the collar hub 204 omits some or all of the feedback mechanisms 224 and instead wirelessly connects to the collar hub 205 to provide those functionalities. The cost and additional complexity of the pet collar 202 created by including the feedback mechanisms 224 is thus avoided, and the pet collar 203 may be a conventional training collar with wireless connectivity. In other implementations, the collar hub 204 includes some or all of the feedback mechanisms 224, but those features are disabled when the collar hub 204 is wirelessly connected to the collar hub 205 to provide those functionalities. This allows the user to use the pet collar 202 exclusively or in conjunction with a trusted training collar, such as the pet collar 203. Either option allows the pet collar 203 to be removed when training steps are not being performed with the pet. In still further implementations, the collar hubs 204, 205 may contain a different combination of the functionalities described above, including identical hubs with varying features enabled. This allows a user to simultaneously use multiple smart pet collars of the same type.

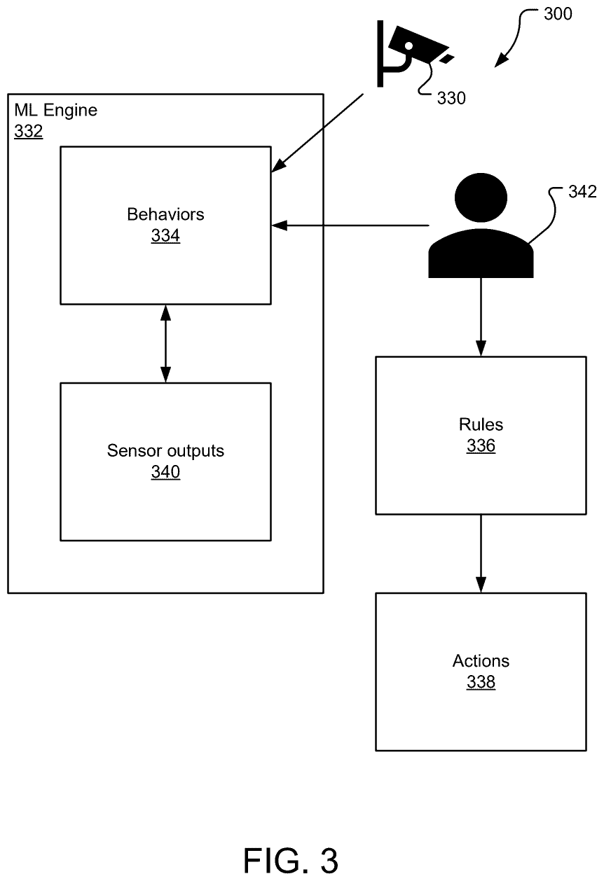

FIG. 3 illustrates a logical diagram 300 of identified behaviors 334, rules 336 set around the behaviors 334, and actions 338 to be taken in response to the behaviors 334 using an inferential smart pet collar (not shown, see e.g., inferential smart pet collar 102 of FIG. 1). The behaviors 334 may be preset and/or user generated. Example preset behaviors include sit, dig, jump, scratch, defecate, and urinate. User-generated behaviors may be specific to a particular dog's behavior or a dog owner's preferences (e.g., jumping in a specific place or at a specific time).

A sensor fusion of outputs from sensors internal to the inferential smart dog collar (e.g., sensors 118 of FIG. 1) and external input devices (e.g., external input devices 130 of FIG. 1) is correlated with specific pet behaviors. An ML engine 332 will correlate the sensor fusion of outputs 340 from the sensors with an input from a user 342, confirming that a specific behavior has occurred. This may occur manually by a user indicating (or confirming) that a specific behavior has occurred. Other implementations may utilize video cameras 330 or microphones (not shown) to confirm that a specific behavior has occurred, and time-stamp the instance of that behavior to correlate to the sensor fusion of outputs 340 from the sensors. As such, the ML engine 332 may refine correlations of outputs 340 from the sensors with specific ones of the behaviors 334 over time to improve inferences of pet behavior using the inferential smart pet collar.

Some implementations may include a training mode and a sensing mode. During the training mode, the inferential smart pet collar is actively collecting a sensor fusion of outputs from sensors and comparing that to the behaviors 334 as confirmed either manually by a user or automatically by the video cameras 330 or other external input devices to have occurred to create a behavior model. Some behavior models may be preloaded on an inferential smart pet collar based on common behaviors and common sensor outputs that suggest the behaviors. However, pets and breeds (e.g., dog breeds) are widely different overall, and dogs within a breed can also be widely different in their behavior. The training mode may allow a user to fine-tune the behavior model based on their specific pet and its behaviors. While there will be similarities from the sensor fusion of the outputs from sensors across the behaviors 334, repeated distinctions are identified by the ML engine 332 and used to distinguish between the behaviors 334 in the training mode.

In some implementations, the user 342 may create their own unique behavior based on their pet's unique characteristics and the user's interest in their pet's behavior. These user activities can be used to refine and expand upon the behaviors 334 over time, particularly as users create similar new behaviors that have common outputs 340 that can be identified with ML. For example, the user 342 may decide to create a new behavior. To do this, the user 342 identifies the new behavior to create and records the pet performing the new behavior, including beginning and end time stamps of the new behavior. This process may be repeated to average and refine the sensor fusion of outputs indicating the new behavior. The user 342 may elect to upload the new behavior and its associated sensor fusion of outputs to shared cloud computing resources (not shown, see e.g., cloud computing resources 114 of FIG. 1). Other implementations may automatically upload the new behavior and the associated sensor fusion of outputs to the shared cloud computing resources. These uploaded new behaviors may then be used to create behaviors 334 for all users, or the new behaviors may be used to refine pre-existing behaviors 334 for all users. In some instances, the user 342 may be incentivized to upload new behaviors to improve the behaviors 334 for all users over time. This iterative improvement in the behaviors 334 available for all users over time is technically advantageous over conventional training data, which is offline, manually implemented, and not iteratively refined over time.

In an example training implementation, the user 342 wishes to train the ML engine 332 to infer a new pet behavior via their smartphone (not shown, see e.g., smartphone 126 of FIG. 1). The user names and loads the new behavior into the behaviors 334 datastore. The user 342 next enters the training mode and takes the pet through the behavior that the user 342 wishes to train. Several training instances may be required to adequately train the ML engine 332 to infer the new pet behavior. For further example, the user 342 may wish to train the ML engine 332 to identify when the pet enters an exclusion zone around an object fixed in space (e.g., the dinner table at particular times of day) or a person that moves wearing a locator (e.g., a toddler). The exclusion zone may also be identified by drawing on a digital map on the user's smartphone. Entry into the exclusion zones may be identified by the ML engine 332 as a specific behavior.

When in the sensing mode, the inferential smart pet collar is still actively collecting a sensor fusion of outputs 340 from the sensors, but is now rendering judgments of what, if any, behavior is currently occurring based on the prior training of the behavior model. In some cases, the training and sensing modes may run simultaneously, rendering judgments of dog behaviors over time, but also options to correct or fine-tune those adjustments (e.g., via cross-reference to a video feed or manual prompts to a user 342 via their smartphone).

Rules 336 may also be defined to direct specific actions 338 to be taken in response to specific inferred behaviors 334. The rules 336 may be preset and/or user-generated. The actions 338 are generally categorized as negative reinforcement to discourage the dog from repeating the behavior or positive reinforcement to encourage the dog to repeat the behavior. An example rule may be that inferred jumping in a particular location (e.g., a front entryway) triggers a corrective negative reinforcement action. Another example rule is that in response to a user's word “sit,” an inferred behavior matching “sit” is detected. This would trigger a positive reinforcement action. Other actions may not be positive or negative reinforcement actions. For example, when the ML engine 332 identifies that the dog has defecated, the ML engine 332 notes the specific location of the waste and notifies the user 342 or triggers an automated cleanup system to retrieve and dispose of the waste as the action.

Other behaviors may not be tied to any rules but are merely present to notify the user of the behavior. For example, the ML engine 332 may merely identify when the dog defecates or urinates, particularly outside, with no corresponding action required. For further example, if the ML engine 332 identifies a persistent change in the dog's gait, this may be reported to the user 342 as a potential injury. For further example, if the ML engine 332 identifies a persistent or increasing time for the dog to rise from a sitting or lying position, this may be reported to the user 342 as a potential onset of arthritis. Some rules are complex and rely on meeting multiple conditions to be met. For example, a rule may define that it is ok for a pet to dig, but not in certain geographic areas (e.g., near a fence). For further example, a rule may define that it is ok for a pet to defecate, but not in a geographic area defined as a playground.

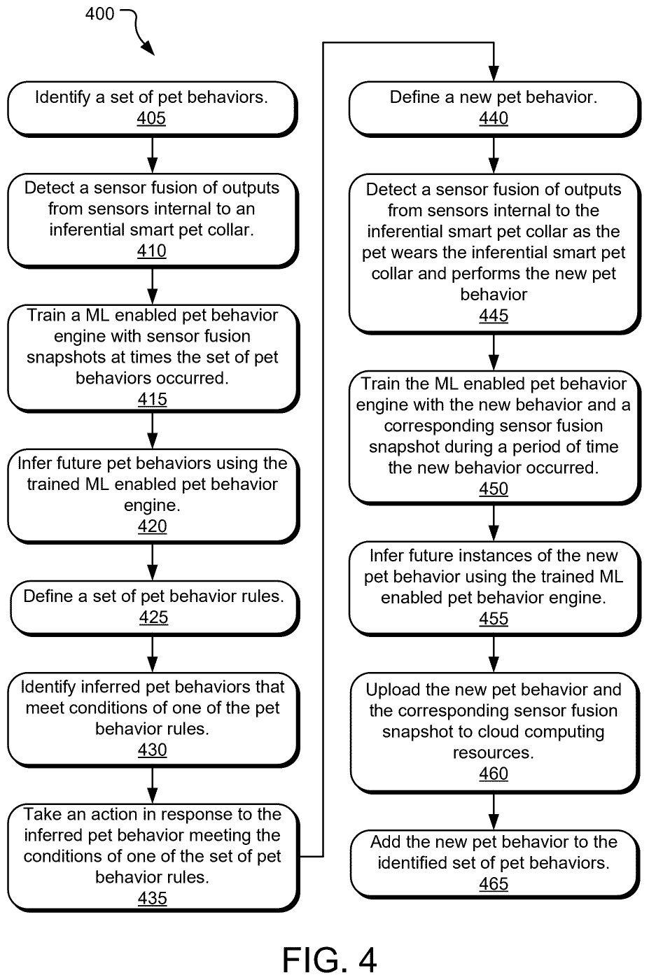

FIG. 4 illustrates an example method 400 for using an inferential smart pet collar to train a pet behavior model and subsequently infer pet behaviors. An identifying operation 405 identifies a set of pet behaviors. These pet behaviors may be a series of pre-existing pet behaviors (e.g., sitting, rolling over, squatting, jumping) combined with custom behaviors specific to a particular pet. A detecting operation 410 detects a sensor fusion of outputs from sensors internal to the inferential smart pet collar as the pet wears the inferential smart pet collar. These sensors may include an IMU, a locating unit, and a microphone, as examples.

A training operation 415 trains a machine-learning (ML) enabled pet behavior engine with sensor fusion snapshots at times the set of pet behaviors occurred. The pet behavior engine can associate each pet behavior with outputs from sensors integral with (and in some cases, external to) the inferential smart pet collar. The pet behavior engine learns what sensor fusion of outputs indicates each past pet behavior. In various implementations, the training operation 415 occurs during an explicit training mode of the inferential smart pet collar.

Using the trained ML-enabled pet behavior engine, an inference operation 420 infers future pet behaviors. The pet behavior engine uses the associations learned in the training operation 415 to accurately predict future pet behaviors with sensor fusion snapshots that match the past and corresponding sensor fusion snapshots with a sufficient degree of certainty. In various implementations, the inferring operation 420 occurs during an explicit sensing mode of the inferential smart pet collar.

A first defining operation 425 defines a set of pet behavior rules. The pet behavior rules may be pet behaviors viewed as positive, negative, or neither positive nor negative, but regardless behaviors that a user is interested in tracking. An identifying operation 430 identifies inferred pet behaviors that meet conditions of one of the pet behavior rules. An action operation 435 takes an action in response to the inferred pet behavior meeting the conditions of one of the pet behavior rules. This action may be a positive reinforcement or a negative reinforcement action. Other actions may be neither positive nor negative (e.g., sending a notification to a user).

In some instances, a user may elect to train the pet behavior engine to recognize a new pet behavior. A second defining operation 440 defines the new pet behavior. The new pet behavior is likely a behavior that does not exist within the set of pet behaviors, but is nonetheless a behavior that the user is interested in monitoring. A second detecting operation 445 detects a sensor fusion of outputs from sensors internal to the inferential smart pet collar as the pet wears the inferential smart pet collar and performs the new pet behavior. A second training operation 450 trains the ML-enabled pet behavior engine with the new behavior and a corresponding sensor fusion snapshot during a period of time during which the new behavior occurred. A second inferring operation 455 infers future instances of the new pet behavior using the trained ML-enabled pet behavior engine. The new pet behavior may become part of the set of pet behaviors for the user.

It may be desirable to make the new pet behavior accessible to additional users. If so, an uploading operation 460 uploads the new pet behavior and the corresponding sensor fusion snapshot to cloud computing resources. An adding operation 465 adds the new pet behavior to the identified set of pet behaviors so that the new pet behavior is accessible to other users who share the cloud computing resources.

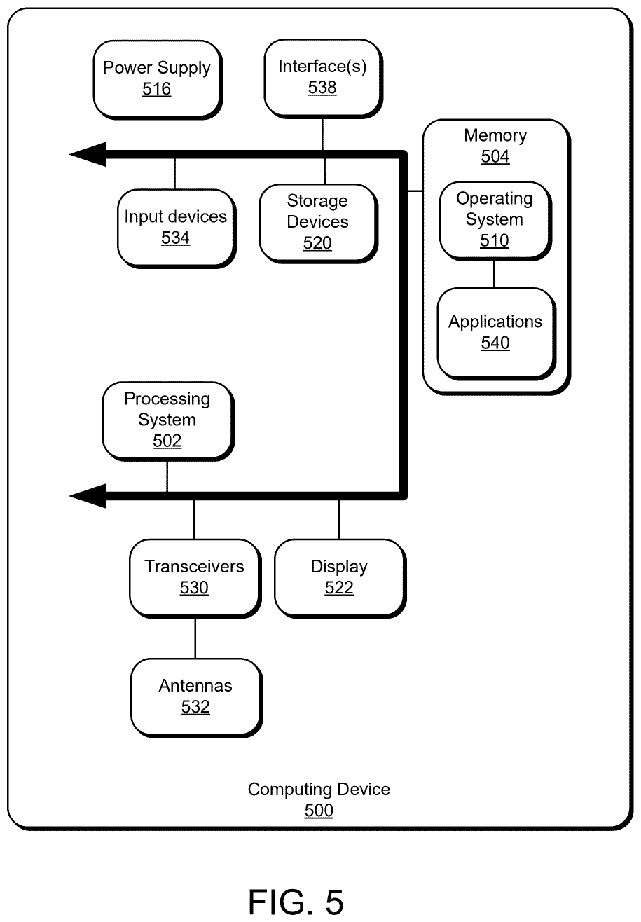

FIG. 5 illustrates an example system diagram of a computing device 500 suitable for implementing aspects of an inferential smart pet collar. In some implementations, the pet collar is the computing device 500 or part of the computing device 500. The computing device 500 may include a processing system 502, memory 504, a display 522, and other interfaces 538 (e.g., buttons). The processing system 502 may include one or more computer processing units (CPUs), graphics processing units (GPUs), etc.

The memory 504 generally may include one or both of volatile memory (e.g., random access memory (RAM)) and non-volatile memory (e.g., flash memory). An operating system 510 may reside in the memory 504 and may be executed by the processing system 502. One or more applications 540 (e.g., the ML engine 332 of FIG. 3) may be loaded in the memory 504 as computer-executable instructions and executed on the operating system 510 by the processing system 502. In other implementations, aspects of the ML engine 332 of FIG. 3 may be loaded into memory of different processing devices connected across a network. The applications 540 may receive inputs from one another as well as from various input local devices 534, such as a microphone, input accessory (e.g., keypad, mouse, stylus, or touchpad), or a camera.

Additionally, the applications 540 may receive input from one or more remote devices, such as remotely located servers or smart devices, by communicating with such devices over a wired or wireless network using more communication transceivers 530 and an antenna 532 to provide network connectivity (e.g., a mobile phone network, Wi-Fi®, Bluetooth®, BLE). The computing device 500 may also include one or more storage devices 520 (e.g., non-volatile storage). Other configurations may also be employed. In one implementation, the ML engine 332 of FIG. 3 is an application executing on the computing device 500 or as a distributed application with different components executing on many different devices.

The computing device 500 further includes a power supply 516, which is powered by one or more batteries or other power sources, and which provides power to other components of the computing device 500. The power supply 516 may also be connected to an external power source (not shown) that overrides or recharges the built-in batteries or other power sources.

The computing device 500 may include a variety of tangible computer-readable storage media and intangible computer-readable communication signals. Tangible computer-readable storage can be embodied by any available media that can be accessed by the computing device 500 and includes both volatile and non-volatile storage media, removable and non-removable storage media. Tangible computer-readable storage media excludes intangible and transitory communications signals and includes volatile and non-volatile, removable, and non-removable storage media implemented in any method or technology for storage of information such as computer-readable instructions, data structures, program modules or other data.

Tangible computer-readable storage media includes RAM, read-only memory (ROM), electrically erasable programmable read-only memory (EEPROM), flash memory or other memory technology, digital versatile disks (DVD) or other optical disk storage, magnetic cassettes, magnetic tape, magnetic disk storage or other magnetic storage devices, or any other tangible medium which can be used to store the desired information, and which can be accessed by the computing device 500. In contrast to tangible computer-readable storage media, intangible computer-readable communication signals may embody computer-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, radio frequency (RF), infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source, compiled, interpreted, executable, static, dynamic, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, depending on the computer system's performance requirements. Accordingly, the logical operations making up the implementations described herein are referred to variously as operations, steps, objects, or modules. Furthermore, logical operations may be performed in any order, adding or omitting operations, unless explicitly claimed otherwise or a specific order is inherently necessitated by the claim language. The above specification, examples, and data provide a complete description of the structure and use of example implementations.

What is claimed is:

1. A method for training a pet behavior model using an inferential smart pet collar comprising:
identifying a set of pet behaviors;
detecting a sensor fusion of outputs from sensors internal to the inferential smart pet collar as a pet wears the inferential smart pet collar;
training a machine-learning (ML) enabled pet behavior engine with sensor fusion snapshots at times the set of pet behaviors occurred; and
inferring future pet behaviors using the trained ML-enabled pet behavior engine.

2. The method of claim 1, further comprising:
defining a set of pet behavior rules; and
identifying an inferred pet behavior that meets one or more conditions of one of the pet behavior rules.

3. The method of claim 2, further comprising:
taking an action in response to the inferred pet behavior meeting the conditions of one of the pet behavior rules.

4. The method of claim 3, wherein the action is one of a positive reinforcement and a negative reinforcement action.

5. The method of claim 1, further comprising:
defining a new pet behavior;
detecting a sensor fusion of outputs from sensors internal to the inferential smart pet collar as the pet wears the inferential smart pet collar and performs the new pet behavior;
training the ML-enabled pet behavior engine with the new pet behavior and a corresponding sensor fusion snapshot during a period of time the new pet behavior occurred; and
inferring future instances of the new pet behavior using the trained ML-enabled pet behavior engine.

6. The method of claim 5, further comprising:
uploading the new pet behavior and the corresponding sensor fusion snapshot to cloud computing resources;
adding the new pet behavior to the identified set of pet behaviors within the cloud computing resources.

7. An inferential smart pet collar comprising:
an inertial measurement unit (IMU) to provide pet orientation data;
a locating unit to provide pet position data; and
a machine-learning (ML) enabled pet behavior engine to infer future pet behaviors using a set of past pet behaviors, the pet orientation data, and the pet position data.

8. The inferential smart pet collar of claim 7, further comprising:
a wireless communications link to connect the inferential smart pet collar to one or more of another inferential smart pet collar, a wide area network (WAN), and a local area network (LAN).

9. The inferential smart pet collar of claim 7, further comprising:
data storage to provide local storage of one or more outputs from the IMU and the locating unit, the set of past pet behaviors, and a set of pet behavior rules.

10. The inferential smart pet collar of claim 9, further comprising:
a processor to execute the ML-enabled pet behavior engine to infer the future pet behaviors.

11. The inferential smart pet collar of claim 10, wherein the processor is further to identify inferred pet behaviors that meet conditions of one of the pet behavior rules.

12. The inferential smart pet collar of claim 11, further comprising:
a feedback mechanism to provide one or both of positive reinforcement and negative reinforcement of an inferred pet behavior, wherein the processor is further to trigger the feedback mechanism in response to the inferred pet behavior meeting the conditions of one of the pet behavior rules.

13. The inferential smart pet collar of claim 12, further comprising:
a training collar to connect to the inferential smart pet collar to provide the feedback mechanism.

14. The inferential smart pet collar of claim 12, wherein the negative reinforcement includes one or more of a sound, vibration, electric shock, and puff of air.

15. The inferential smart pet collar of claim 12, wherein the positive reinforcement includes remotely activating an automatic treat feeder or pinging a user to provide a treat or play time to the pet.

16. The inferential smart pet collar of claim 7, further comprising:
one or more external input devices to provide additional data sourced external to the inferential smart pet collar, the additional data also used to infer the future pet behaviors.

17. The inferential smart pet collar of claim 7, further comprising:
an external hub to control features of the inferential smart pet collar.

18. One or more computer-readable storage media encoding computer-executable instructions for executing on a computer system a computer process that trains a pet behavior model using an inferential smart pet collar, the computer process comprising:
identifying a set of pet behaviors;
detecting a sensor fusion of outputs from sensors internal to the inferential smart pet collar as a pet wears the inferential smart pet collar;
training a machine-learning (ML) enabled pet behavior engine with sensor fusion snapshots at times the set of pet behaviors occurred; and
inferring future pet behaviors using the trained ML-enabled pet behavior engine.

19. The computer-readable storage media of claim 18, wherein the computer process further comprises:
defining a set of pet behavior rules;
identifying an inferred pet behavior that meets one or more conditions of one of the pet behavior rules;
taking an action in response to the inferred pet behavior meeting the conditions of one of the pet behavior rules.

20. The computer-readable storage media of claim 18, wherein the computer process further comprises:
defining a new pet behavior;
detecting a sensor fusion of outputs from sensors internal to the inferential smart pet collar as a pet wears the inferential smart pet collar;
training the ML-enabled pet behavior engine with the new behavior and a corresponding sensor fusion snapshot during a period of time the new behavior occurred; and
inferring future instances of the new pet behavior using the trained ML-enabled pet behavior engine.
